(19) United States
(12) Patent Application Publication
(10) Pub. No.: US 2012/0274770 A1
(43) Pub. Date: Nov. 1, 2012

(54) VEHICLE IMAGE RECORDING SYSTEM

(75) Inventor: Jae Hoon LEE, Yongin (KR)

(73) Assignee: SAMSUNG ELECTRO-MECHANICS CO., LTD., Suwon (KR)

(21) Appl. No.: 13/458,306

(22) Filed: Apr. 27, 2012

(30) Foreign Application Priority Data
Apr. 29, 2011 (KR) 10-2011-0040482

(51) Int. Cl. H04N 7/18

(52) U.S. Cl. 348/148; 348/E07.085

(57) ABSTRACT

There is provided a vehicle image recording system including: a vehicle having a receiving space provided therein; a camera installed in the receiving space; a reflective device installed on a window of the vehicle or a ceiling of the vehicle to reflect image information captured from the front or the rear of the vehicle, to the camera; and a fixing member fixing the reflective device to the window or the ceiling.

### CROSS-REFERENCE TO RELATED APPLICATIONS

This application claims the priority of Korean Patent Application No. 10-2011-0040482 filed on Apr. 29, 2011, in the Korean Intellectual Property Office, the disclosure of which is incorporated herein by reference.

### BACKGROUND OF THE INVENTION

1. Field of the Invention

The present invention relates to a vehicle image recording system, and more particularly, to a vehicle image recording system installed in a vehicle, or the like, to image and store traffic and accident situations in front and rear directions from the vehicle.

2. Description of the Related Art

As a method of accurately investigate the cause of a traffic accident, a method of installing a forward-facing monitoring apparatus (for example, a camera) behind a vehicle windshield has gradually expanded.

The forward-facing monitoring apparatus installed in the vehicle images and stores a recording of an accident occurring around the vehicle as well as an accident of the vehicle itself. Therefore, when stored image information from the forward-facing monitoring apparatus is analyzed, even in a case in which there is no witness at the scene of a vehicle accident, a cause of the vehicle accident may be accurately determined.

Meanwhile, the forward-facing monitoring apparatus may be mounted behind the vehicle windshield in order to widely and accurately monitor the situation occurring forward of the vehicle.

However, since a vehicle windshield may be easily broken by an impact at the time of an accident and is significantly affected by direct sunlight, the forward-facing monitoring apparatus may be damaged and become overheated.

Therefore, the development of a forward-facing monitoring apparatus having a structure capable of reducing an influence of an external impact and direct sunlight has been urgently demanded.

In addition, the development of a forward-facing monitoring apparatus having an imaging direction easily adjusted according to a driver's gaze or a direction of movement of a vehicle has also been demanded.

### SUMMARY OF THE INVENTION

An aspect of the present invention provides a vehicle image recording system capable of preventing damage to a camera due to impacts and reducing degradation of camera performance and lifespan due to direct sunlight.

According to an aspect of the present invention, there is provided a vehicle image recording system including: a vehicle having a receiving space provided therein; a camera installed in the receiving space; a reflective device installed on a window of the vehicle or a ceiling of the vehicle to reflect image information captured from the front or the rear of the vehicle, to the camera; and a fixing member fixing the reflective device to the window or the ceiling.

The vehicle image recording system may further include an impact absorbing unit installed in the receiving space to protect the camera from an external impact.

The impact absorbing unit may include: a camera housing receiving the camera therein; and a filling member filling the camera housing.

The reflective device may be installed on a rearview mirror included in the vehicle.

The reflective device may include: a reflective member reflecting image information of the front of the vehicle to the camera; and an operating fluid allowing the reflective member to be inclined in a turning direction of the vehicle through centrifugal force generated when the vehicle is driven or turned on a winding road.

The reflective device may include a reflective member having multiple surfaces or a reflective member having a single curved surface.

The receiving space may be provided between the ceiling and a roof of the vehicle.

The receiving space may be further installed with a ventilation unit circulating air in an interior of the vehicle to the receiving space.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a vehicle image recording system according to a first embodiment of the present invention;

FIG. 2 is a configuration diagram of a vehicle image recording system according to a second embodiment of the present invention;

FIG. 3 is a cross-sectional view showing an impact absorbing unit shown in FIG. 2;

FIG. 4 is a configuration diagram of a vehicle image recording system according to a third embodiment of the present invention;

FIG. 5 is a configuration diagram of a vehicle image recording system according to a fourth embodiment of the present invention;

FIG. 6 is a diagram describing a driver's gaze direction according to driving of a vehicle on a winding road;

FIG. 7 is a diagram showing an example of a reflective device suitable for driving a vehicle on a winding road and a vehicle included the same; and

FIGS. 8 through 13 are diagrams describing another example of a reflective device suitable for driving a vehicle on a winding road and the principle thereof.

### DETAILED DESCRIPTION OF THE EMBODIMENTS

Hereinafter, embodiments of the present invention will be described in detail with reference to the accompanying drawings.

In describing the present invention below, terms denoting components of the present invention are named in consideration of the functions thereof. Therefore, the terms should not be understood as being limited technical components of the present invention.

Meanwhile, even though a case in which a vehicle image recording system according to embodiments of the present invention monitors the front area of a vehicle is described and shown in the present specification and the accompanying drawings, it is merely an example. The vehicle image recording system may therefore also be used as an apparatus monitoring the rear area or the side areas of the vehicle, as necessary.

### First Embodiment

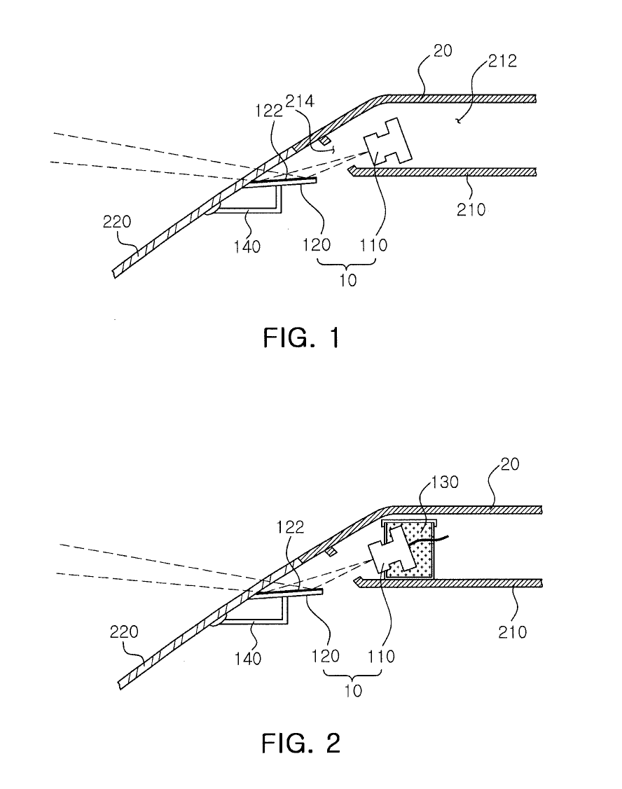

FIG. 1 is a configuration diagram of a vehicle image recording system according to a first embodiment of the present invention.

A vehicle image recording system 10 according to the first embodiment of the present invention may include a camera 110 and a reflective device 120.

The camera 110 may be installed on a ceiling 210 of a vehicle 20. In addition, the camera 110 may be installed in an internal space 212 of the ceiling 210 so as not to obstruct a driver or a passenger ride, while simultaneously being protected from an external impact applied to the vehicle 20. In order to install the camera 110 in an inner portion of the ceiling 210, the internal space 212 formed between the ceiling 210 and a roof may be used as it is. However, a separate space may also be formed in the ceiling 210 as needed. For reference, the ceiling 210 may be provided with a hole 214 such that light reflected from a subject may be incident to a lens of the camera 110.

The camera 110 has a function of continuously imaging and storing an image incident through a windshield 220 of the vehicle 20 when the vehicle 20 is in motion or is stopped. In addition, the camera 110 may have a day imaging mode function and a night imaging mode function. For example, in the day imaging mode, an IR cut-off filter filtering infrared rays may be used. On the other hand, in the night imaging mode, a visible ray cut-off filter may be used so as to allow for infrared ray imaging. Here, a shape and a function of the camera 110 may be changed and modified to any shape and function within a range recognized by those skilled in the art to which the present invention pertains.

The reflective device 120 may be installed on the windshield 220 or the ceiling 210 of the vehicle 20. The reflective device 120 may include a reflective member 122, and a position of the reflective device 120 may be fixed by a support member 140. The reflective member 122 may reflect image information captured from the front of the vehicle 20 to the camera 110.

Meanwhile, the reflective device 120 may have a structure capable of adjusting a reflection angle of the reflective member 122 as needed by a driver. For example, the reflective device 120 may be installed on the support member 140 via a ball joint (not shown).

The vehicle image recording system 10 configured as described above may be relatively securely protected from impacts transferred from the front and the sides of the vehicle, since a relatively expensive the camera 110, which is relatively expensive, is installed on the ceiling 210 of the vehicle 20.

In addition, according to the embodiment, since the camera 110 is not exposed directly to direct sunlight, even in the case in which the vehicle 20 is exposed outside for a long period of time, a problem in which an internal temperature of the camera 110 rapidly rises due to the direct sunlight may be reduced.

### Second Embodiment

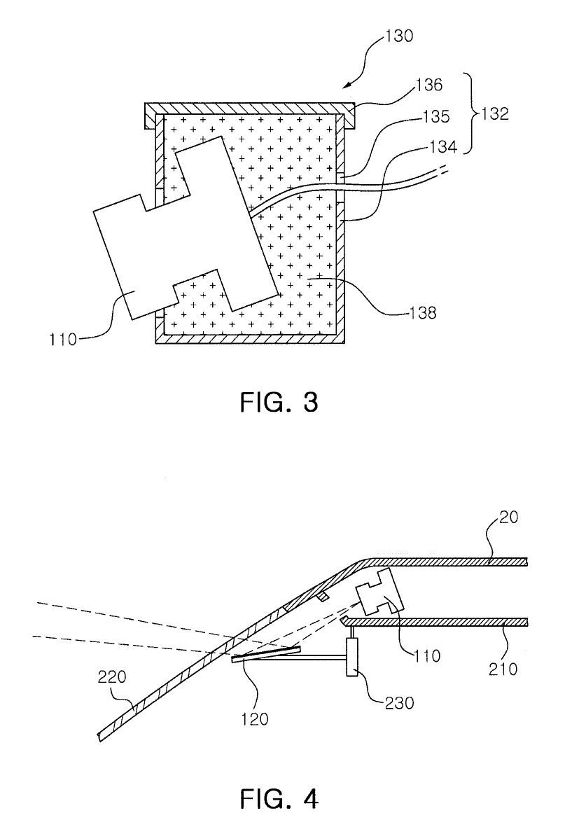

FIG. 2 is a configuration diagram of a vehicle image recording system according to a second embodiment of the present invention; and FIG. 3 is a cross-sectional view showing an impact absorbing unit shown in FIG. 2. For reference, in the second embodiment of the present invention, components that are the same as those of the first embodiment of the present invention will be denoted by the same reference numerals and a detailed description thereof will be omitted.

The vehicle image recording system 10 according to the second embodiment of the present invention may further include an impact absorbing unit 130.

The impact absorbing unit 130 may be installed on the ceiling 210 of the vehicle 20, similarly to the camera 110, and block impacts applied to the vehicle 20 from being transferred directly to the camera 110. According to the embodiment, the impact absorbing unit 130 may include a camera housing 132 and a filling member 138 as shown in FIG. 3.

The camera housing 132 may include a camera housing body 134 receiving the camera 110 and a camera housing cover 136. The camera housing body 134 may have an open top surface (in a direction based on FIG. 3) such that the camera 110 may be installed therein and have an open front surface (in a direction based on FIG. 3) such that a portion (a lens portion) of the camera 110 may be exposed. In addition, a surface of the camera housing body 134 may be provided with a hole 135 through which an electric wire connected to the camera 110 is drawn out. The camera housing cover 136 may cover the top surface of the camera housing body 134. The camera housing cover 136 may prevent the camera 110 from being separated from the camera housing body 134.

The filling member 138 may fill an internal space of the camera housing 132 in a state in which the camera 110 is installed in the camera housing 132. Here, the filling member 138 may be injected through the opened surfaces or the hole 135 of the camera housing body 134. The filling member 138 filling the internal space of the camera housing 132 as described above may prevent the camera 110 from arbitrarily moving in the internal space of the camera housing 132 and protect the camera 110 from impacts applied to the camera housing 132.

For reference, the filling member 138 may be modified to any member and have any shape as long as it may be a material capable of absorbing external impacts, such as Styrofoam, sponge, or the like, in addition to a foaming resin.

In the vehicle image recording system 10, according to the embodiment configured as described above, since the camera 110 is installed on the ceiling 210 via the impact absorbing unit 130, the camera 110 may be protected from impacts applied to the ceiling 210 of the vehicle 20 as well as the front and the sides of the vehicle 20.

### Third Embodiment

FIG. 4 is a configuration diagram of a vehicle image recording system according to a third embodiment of the present invention. For reference, in the third embodiment of the present invention, components that are the same as those of the first embodiment of the present invention will be denoted by the same reference numerals and a detailed description thereof will be omitted.

The vehicle image recording system 10 according to the third embodiment of the present invention is different in terms of an installation form of the reflective device 120 from the vehicle image recording systems according to the above-mentioned embodiments of the present invention.

According to the embodiment, the reflective device 120 may be installed on a rearview mirror 230 provided in the vehicle 20. More specifically, the reflective device 120 or the reflective member 122 may be installed on a front surface of the rearview mirror 230 to reflect image information incident through the windshield 220 to the camera 110.

Since the vehicle image recording system 10 according to the embodiment configured as described above does not require the support member 140, which is separate member, costs requiring for manufacturing the vehicle image recording system 10 may be reduced, and the reflective device 120 may be easily installed.

### Fourth Embodiment

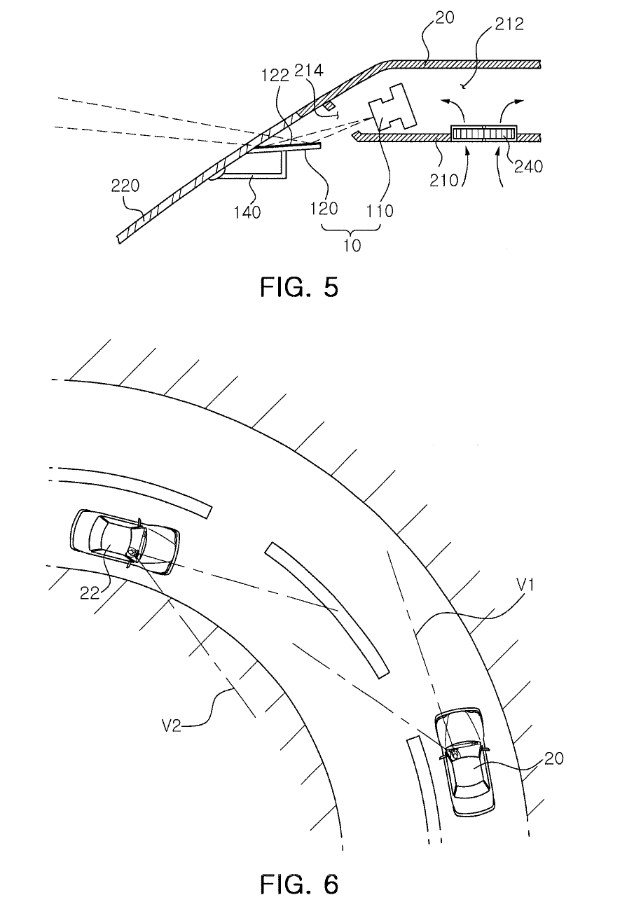

FIG. 5 is a configuration diagram of a vehicle image recording system according to a fourth embodiment of the present invention. For reference, in the fourth embodiment of the present invention, components that are the same as those of the first embodiment of the present invention will be denoted by the same reference numerals and a detailed description thereof will be omitted.

The vehicle image recording system 10 according to the present embodiment may further include a ventilation device 240.

The ceiling 210 of the vehicle 20 may be generally covered by a heat insulating material in order to block direct sunlight and external heat or cool air from being introduced into the vehicle. However, in the case in which the vehicle 20 is parked in an outdoor parking zone for a long period of time, or the vehicle 20 is driven for a long period of time during the hot summer or autumn, when sunlight is strong, thermal energy through direct sunlight is concentrated on the ceiling 210 of the vehicle 20, such that a temperature in the internal space 212 of the ceiling 210 may significantly rise.

In contrast, an inner portion of the vehicle may be maintained at a relatively low temperature, as compared to the internal space 212 of the ceiling 210, since a driver operates an air conditioner in order to maintain a comfortable temperature in the inner portion of the vehicle.

In the embodiment, in consideration of this point, the ventilation device 240 is provided on the ceiling 210. The ventilation device 240 may be installed on the ceiling 210, and circulate air in the inner portion of the vehicle so as to allow the air to be introduced in the internal space 212 of the ceiling 210. The ventilation device 240 may have a fan shape generating forced circulation of the air or a simple vent hole shape enabling natural air convection.

In the vehicle image recording system 10 according to the embodiment configured as described above, since relatively low temperature air may be continuously supplied to the internal space 212 of the ceiling 210, a fault or performance deterioration phenomenon of the camera 110 due to a high temperature may be effectively prevented.

### Fifth Embodiment

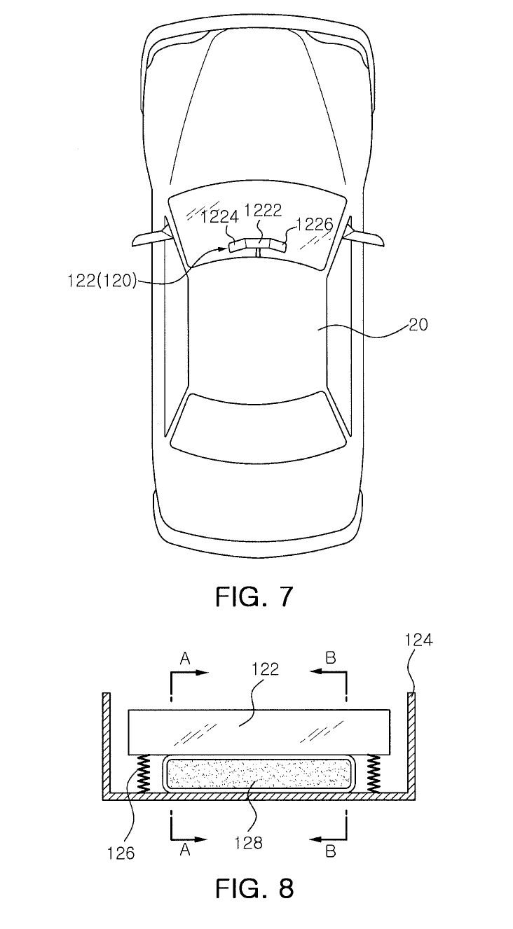

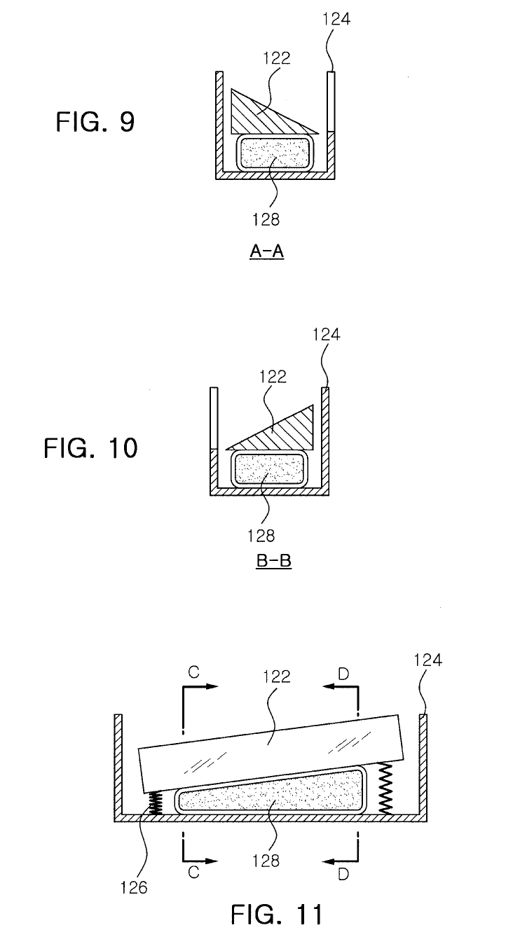

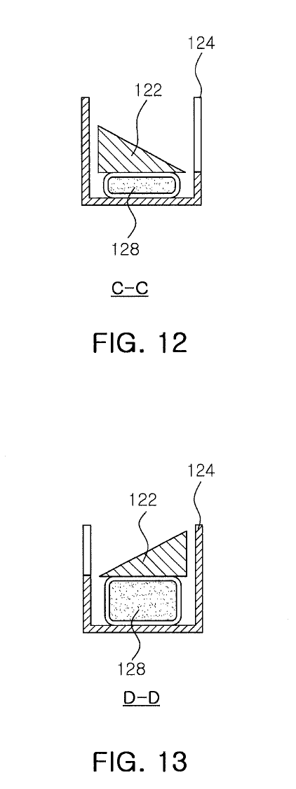

FIG. 6 is a diagram describing a driver's gaze direction according to driving of a vehicle on a winding road; FIG. 7 is a diagram showing an example of a reflective device suitable for driving a vehicle on a winding road and a vehicle included the same; and FIGS. 8 through 13 are diagrams describing another example of a reflective device suitable for driving a vehicle on a winding road and the principle thereof. Here, FIG. 9 is a cross-sectional view taken along line A-A of FIG. 8; FIG. 10 is a cross-sectional view taken along line B-B of FIG. 8; FIG. 12 is a cross-sectional view taken along line C-C of FIG. 11; and FIG. 13 is a cross-sectional view taken along line D-D of FIG. 11.

On a winding road having a small turning radius, since it is difficult to predict the presence of a vehicle 20 or 22 on the other side of the road, as shown in FIG. 6, a collision between vehicles 20 and 22 may frequently occur. Therefore, drivers driving vehicles on the winding road direct their gazes V1 and V2 toward a direction in which it is predicted that the vehicle 20 or 22 on the other side of the road will appear, in order to avoid the collision with the oncoming vehicle 20 or 22.

Therefore, in the case in which the vehicles 20 and 22 are in motion on winding road, it is preferable to obtain image information in a direction in which the collision between the vehicles 20 and 22 is predicted.

In the embodiment, in consideration of this point, the following two kinds of reflective devices 120 are suggested.

(First Embodiment of Reflective Device)

A first embodiment of the reflective device 120 may include the reflective member 122 having several reflective surfaces as shown in FIG. 7. That is, the reflective member 122 may include a first reflective surface 1222, a second reflective surface 1224, and a third reflective surface 1226.

Here, the first reflective surface 1222 may reflect image information regarding a central portion of an area in front of the vehicle, the second reflective surface 1224 may reflect image information regarding a left side of the area in front of the front of the vehicle, and the third reflective surface 1226 may reflect image information regarding a right side of the area in front of the vehicle.

Since the reflective member 122 as described above reflects image information having a relatively wider range to the camera 110, as compared to a reflective member having a single reflective surface, the image information including the driver's gazes V1 and V2 may be stored in the camera 110.

That is, when the reflective member 122 according to the embodiment is used, all of the image information reflected through the reflective surfaces 1222, 1224, and 1226 may be incident to the camera 110 and be stored therein.

For reference, although FIG. 7 shows that the reflective member 122 has several reflective surfaces, the reflective member 122 may be changed to have a curved reflective surface as needed.

(Second Embodiment of Reflective Device)

A second embodiment of the reflective device 120 may include the reflective member 122, a housing 124, elastic members 126, and an operating fluid 128, as shown in FIG. 8.

The reflective member 122 may generally have a pillar shape having a triangular cross section and include a reflective surface on an oblique plane. The reflective member 122 may be installed in the housing 124.

The housing 124 may receive the reflective member 122 therein. In order to allow image information to be incident on the reflective surface, a surface of the housing 124 facing the reflective surface of the reflective member 122 or the entirety of the housing 124 may be formed of a transparent material. The housing 124 configured as described above may be fixed to the windshield 220 or the ceiling 210 through the support member 140 shown in FIG. 1.

The elastic members 126 may connect the reflective member 122 and the housing 124 to each other. In addition, the elastic members 126 may maintain the reflective member 122 in a horizontal state at a predetermined height with respect to a bottom surface of the housing 124. Each of the elastic members 126 may be installed at both ends of the reflective member 122.

The operating fluid 128 may be installed in the housing 124 in a state in which it is sealed by a sealing bag. The operating fluid 128 may be disposed under the reflective member 122 to support the reflective member 122 at a predetermined height. Here, the operating fluid 128 is a liquid material that may move freely, such that the operating fluid 128 may be biased toward a left direction or a right direction (based on FIGS. 8 and 11) of the housing 124 according to a turning direction of the vehicles 20 and 22.

An operating principle of the reflective device 120 configured as described above will be described with reference to FIGS. 11 through 13.

A turning object has centrifugal force applied from the center of rotation to the outside thereof. Therefore, when the vehicles 20 and 22 turn rapidly, the operating fluid 128 of the housing 124 may be biased towards one direction (that is, a direction opposite to the center of rotation) by centrifugal force, as shown in FIG. 11.

Therefore, the operating fluid 128 disposed under the reflective member 122 is non-uniformly distributed, such that the reflective member 122 is inclined in one direction by the operating fluid 128. Here, the direction in which the reflective member 122 is inclined may coincide with a direction in which the collision between the vehicles is frequently generated on the winding road.

Meanwhile, an inclination of the reflective member 122 may be increased or decreased according to a driving speed of the vehicles 20 and 22 and a radius size of the winding road. For example, the bias (or the inclination) of the operating fluid 128 may be larger in the case in which the vehicles 20 and 22 turn on a winding road at a high speed, as compared to the case in which the vehicles 20 and 22 turn on the winding road at a low speed. In addition, the bias (or the inclination) of the operating fluid may be larger in the case in which the vehicles 20 and 22 are driven on a winding road having a relatively small turning radius, as compared to case in the case in which the vehicles 20 and 22 are driven on a winding road having a relatively large turning radius.

According to the second embodiment of the reflective member configured as described above, an area forward of the vehicle to be imaged, is automatically adjusted by the reflective member 122, according to a movement state of the vehicle 20, whereby a collision situation between vehicles on a winding road may be more accurately and effectively imaged through the camera 110.

Further, in the second embodiment of the reflective member, a relatively narrow area is imaged, unlike in the first embodiment in which a wide area is imaged, whereby file size of a moving image stored in the camera 110 may be reduced.

Therefore, according to the embodiment, a larger amount of moving images may be stored in a camera having the same storage capacity.

As set forth above, according to the embodiments of the present invention, the camera is installed on the ceiling of the vehicle relatively less subjected to external impacts, whereby damage of the camera due to vehicle rear end collision or vehicle collision and a cost required to repair the monitoring apparatus according to the damage may be significantly reduced.

In addition, according to the embodiments of the present invention, an imaging direction of the camera according to a direction of movement of the vehicle is automatically changed, whereby an accident occurring in the direction of movement of the vehicle may be more accurately monitored.

While the present invention has been shown and described in connection with the embodiments, it will be apparent to those skilled in the art that modifications and variations can be made without departing from the spirit and scope of the invention as defined by the appended claims.

What is claimed is:

1. A vehicle image recording system comprising:
a vehicle having a receiving space provided therein;
a camera installed in the receiving space;
a reflective device installed on a window of the vehicle or a ceiling of the vehicle to reflect image information captured from the front or the rear of the vehicle, to the camera; and
a fixing member fixing the reflective device to the window or the ceiling.

2. The vehicle image recording system of claim 1, further comprising an impact absorbing unit installed in the receiving space to protect the camera from an external impact.

3. The vehicle image recording system of claim 2, wherein the impact absorbing unit includes:
a camera housing receiving the camera therein; and
a filling member filling the camera housing.

4. The vehicle image recording system of claim 1, wherein the reflective device includes:
a reflective member reflecting image information of the front of the vehicle to the camera; and
an operating fluid allowing the reflective member to be inclined in a turning direction of the vehicle through centrifugal force generated when the vehicle is driven or turned on a winding road.

5. The vehicle image recording system of claim 1, wherein the reflective device includes a reflective member having multiple surfaces or a reflective member having a single curved surface.

6. The vehicle image recording system of claim 1, wherein the receiving space is provided between the ceiling and a roof of the vehicle.

7. The vehicle image recording system of claim 1, wherein the receiving space is further installed with a ventilation unit circulating air in an interior of the vehicle to the receiving space.
